(19) United States
(12) Patent Application Publication
(10) Pub. No.: US 2005/0174337 A1
(43) Pub. Date: Aug. 11, 2005

(54) Electronic handheld drawing and gaming system using television monitor

(76) Inventors: Paul S. Nielsen, Saratoga Springs, NY (US); Chris Dooley, Stamford, CT (US); Loren Taylor, Chatham, NJ (US)

Correspondence Address: FRASER MARTIN BUCHANAN MILLER LLC, 132C WEST SECOND STREET, PERRYSBURG, OH, 43551-1401, US

(21) Appl. No.: 11/055,393

(22) Filed: Feb. 10, 2005

Related U.S. Application Data
(60) Provisional application No. 60/543,641, filed on Feb. 11, 2004.

(51) Int. Cl. G09G 5/00

(52) U.S. Cl. 345/173

(57) ABSTRACT

An electronic handheld device outputs video signals to a video monitor to create an image. A controller generates video signals for defining a menu area and an active window on the visual display. The menu area includes a plurality of selection icons generally aligned on the visual display for accessing respective imaging functions to be carried out in the active window. The device includes a first and second directional inputs mounted on the housing for manipulating using first and second hands of a user, respectively. A first set of push buttons is mounted on the housing juxtaposed with the first directional input for activating using the first hand of the user. A second set of push buttons is mounted on the housing juxtaposed with the second directional input for activating using the second hand of the user. The controller responds to the first directional input and the second set of push buttons for selecting a desired one of the selection icons. The controller responds to the second directional input and the first set of push buttons to selectively alter an image within the active window to perform the imaging functions.

### CROSS-REFERENCE TO RELATED APPLICATION

This application claims priority to U.S. provisional application 60/543,641, filed Feb. 11, 2004.

### STATEMENT REGARDING FEDERALLY SPONSORED RESEARCH

Not applicable

### BACKGROUND OF THE INVENTION

The present invention relates in general to an electronic handheld device for controlling video drawing and gaming applications, and, more specifically, to an easy to use, low cost electronic toy used in conjunction with a television monitor.

Handheld video game units have been introduced with various designs. A wide variety of programmed games and activities have been developed. Many different switches, buttons, knobs, and joysticks have been employed to provide a user interface for controlling game actions. A user or player typically creates movement of screen objects using directional or positional controls such that pushing a control element (e.g., joystick or thumb pad) in a desired direction causes corresponding movement of a game object on the video monitor. Making selections from a plurality of choices (e.g., a menu) or initiating predetermined actions within a game or activity are typically achieved using various kinds of push buttons.

In feature rich games and activities with lots of potential actions, the number and types of control elements used by individual handheld game units is sometimes quite large. Some control actions require simultaneous manipulation of separate control elements using both hands. Other situations may require the player to reposition their fingers or hands to different areas of a unit. Because of the variety of potential finger/hand motions and the large number of combinations of control element actuations, it can be difficult for the player to remember them all (especially for devices intended for younger children).

What is needed for a handheld video game and activity device is a simple, intuitive user interface that is easy to use and fun to learn while remaining versatile and presenting a user with a large number of potential activities and control actions. It would be further desirable to achieve the foregoing in a device that is easy to hold and manipulate and that can be manufactured at a low cost.

### SUMMARY OF THE INVENTION

The present invention overcomes the disadvantages of the prior art and meets the foregoing objectives by providing an intuitive, easy to learn interface using a simple and efficient button layout with simple screen layouts and menu bars.

In one aspect of the invention, an electronic handheld device is provided for outputting video signals to a video monitor with a visual display to create an image. The device includes a housing and a controller mounted in the housing for generating video signals for defining a menu area and an active window on the visual display. The menu area includes a plurality of selection icons generally aligned on the visual display for accessing respective imaging functions to be carried out in the active window. The device includes a first directional input mounted on the housing for manipulating using a first hand of a user. A second directional input is mounted on the housing for manipulating using a second hand of the user. A first set of push buttons is mounted on the housing juxtaposed with the first directional input for activating using the first hand of the user. A second set of push buttons is mounted on the housing juxtaposed with the second directional input for activating using the second hand of the user. The controller responds to the first directional input and the second set of push buttons for selecting a desired one of the selection icons. The controller responds to the second directional input and the first set of push buttons to selectively alter an image within the active window to perform the imaging functions.

### BRIEF DESCRIPTION OF THE DRAWINGS

FIG. 1 is a top perspective view of one embodiment of a handheld device according to the present invention interconnected with a video monitor.

FIG. 2 is a perspective view of one embodiment of an expansion cartridge of the present invention.

FIG. 3 is a bottom perspective view of the device of FIG. 1.

FIGS. 4A-4D provide a schematic diagram of the electronic circuitry utilized in one preferred example of the device incorporating the present invention.

FIG. 5 is an exploded, perspective view of the device.

FIG. 6 is a flowchart showing a preferred embodiment of an operating method of the present invention.

FIG. 7 is a screen shot showing one example of a main menu screen of the invention.

FIG. 8 is a screen shot showing an image creation activity.

FIG. 9 shows a sub-menu bar corresponding to a drawing command function.

FIG. 10 shows a sub-menu bar corresponding to a painting command function.

FIG. 11 is a screen shot showing a matrix of clip art graphic elements presented as a sub-menu in the active window.

FIG. 12 is a screen shot showing an animation activity.

FIG. 13 shows the separation of the active window into zones for receiving animated graphic elements.

FIG. 14 is a screen shot showing a maze game

### DESCRIPTION OF PREFERED EMBODIMENTS

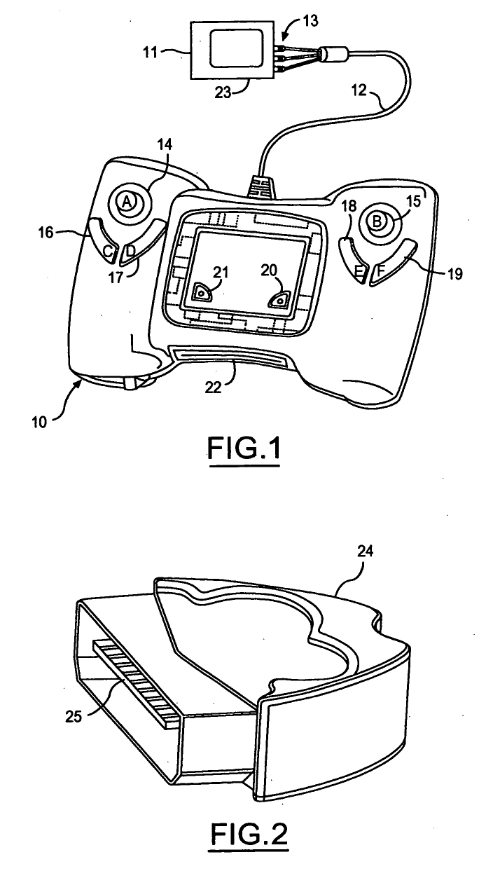

Referring to FIG. 1, the handheld electronic device 10 is shown as one straightforward example of a unit employing the concepts of the present invention. It interconnects with a video monitor 11 such as a television in a home or a video monitor in an automobile via a connector cable 12 which includes standard composite video and audio connector jacks 13 at one end. Monitor 11 includes a visual display 23 such as a CRT, an LCD screen, or a plasma screen. Monitor 11 may also include stereo speakers (not shown) for reproducing sound effects or music.

Device 10 includes a housing or outer shell through which protrude 4-way selector controls 14 and 15, push buttons 16-19, an on/off button 20, and a menu or reset button 21. 4-way selector controls 14 and 15 are labeled with letters “A” and “B” and are preferably controlled by the user's left and right thumbs, respectively. Each selector control generates directional signals from four contact switches when the selector control is moved up, down, left, or right. Directional signals can be generated representing diagonal directions when two adjacent contact switches are actuated simultaneously (e.g., the up and right switches to indicate the upper right diagonal direction).

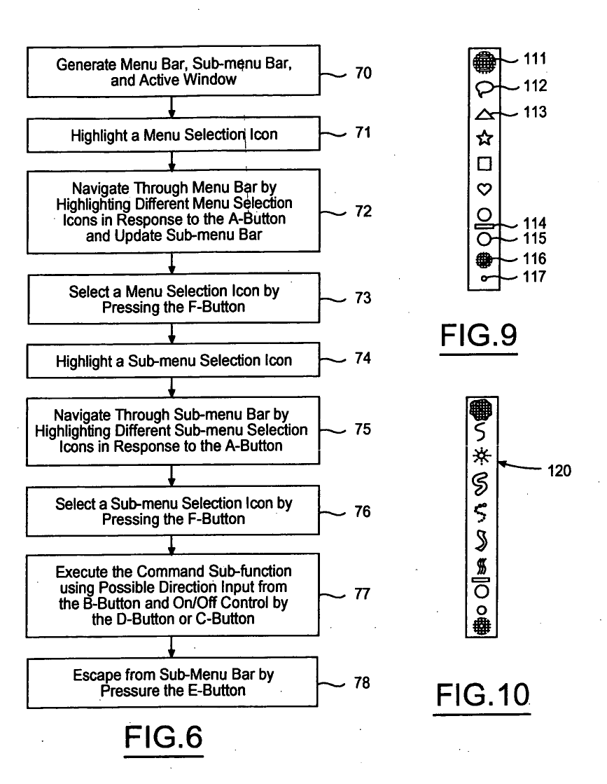

Push buttons 16 and 17 are labeled “C” and “D” and are juxtaposed with selector control 14. By placing push buttons 16 and 17 below and substantially adjacent with control 14, all three control elements can be easily manipulated by the left thumb. Push buttons 18 and 19 are labeled “E” and “F” and are juxtaposed with selector control 15. By placing push buttons 18 and 19 below and substantially adjacent with control 15, all three control elements can be easily manipulated by the right thumb. The present invention provides an easy to learn yet versatile user interface by associating manipulation of one selector control (e.g., A-button 14) and the set of push buttons for the other hand (e.g., E-button 18 and F-button 19) with certain types of command functions and by associating manipulation of the other selector control (e.g., B-button 15) and the set of push buttons for the other hand (e.g., C-button 16 and D-button 17) with certain other types of command functions. For example, buttons A, E, and F may be associated with menu navigation while buttons B, C, and D may be associated with actions within the active screen window (e.g., drawing or directing game movements) as described more fully below in connection with FIGS. 6-14.

The housing shell of device 10 includes an opening 22 for receiving expansion cartridges such as a cartridge 24 shown in FIG. 2. A printed circuit board mounted inside device 10 and exposed within opening 22 includes an edge connector 43 for receiving a circuit board 25 of cartridge 24.

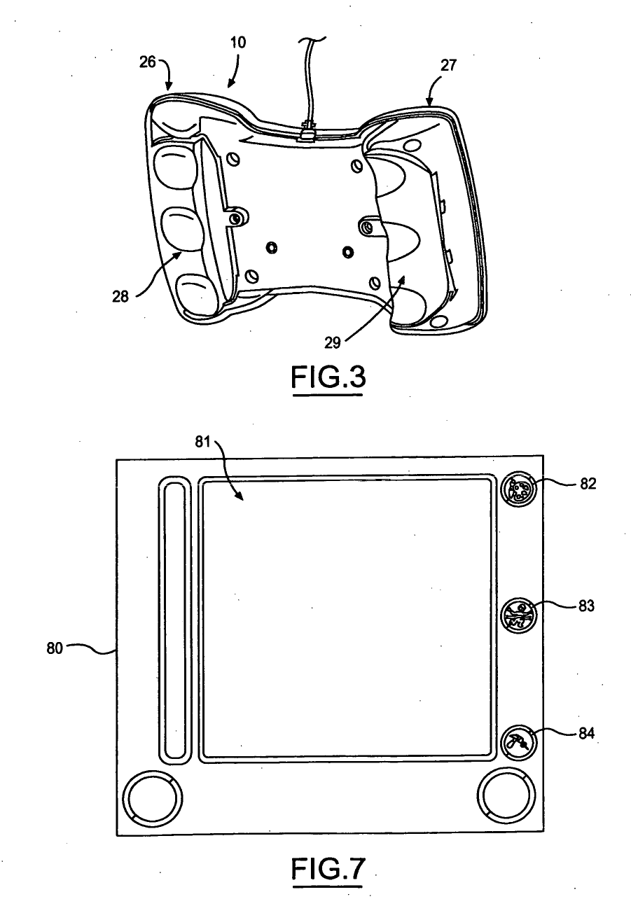

FIG. 3 is a rear perspective view of device 10. Outer gripping edges or handles 26 and 27 include removable back panels 28 and 29 with finger grooves for providing a comfortable grip. Panels 28 and 29 are secured by screws to protect a pair of battery compartments that receive standard AA batteries for powering the device.

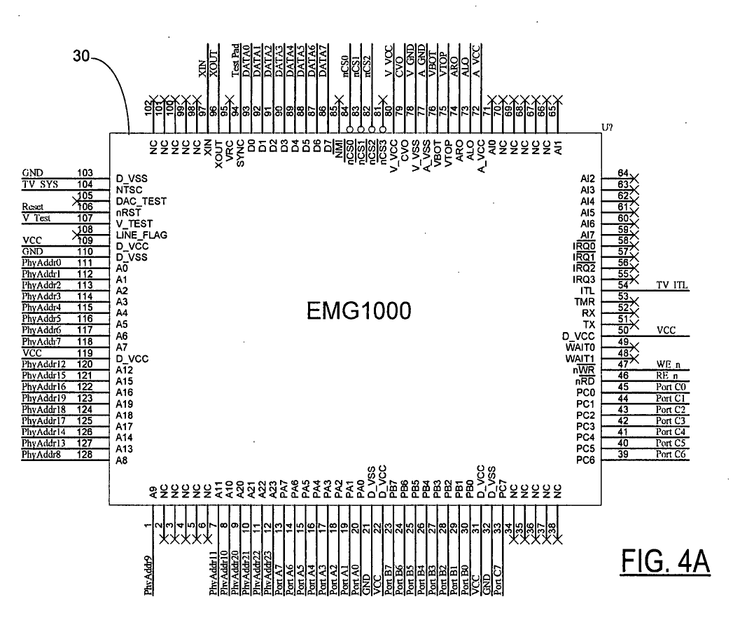

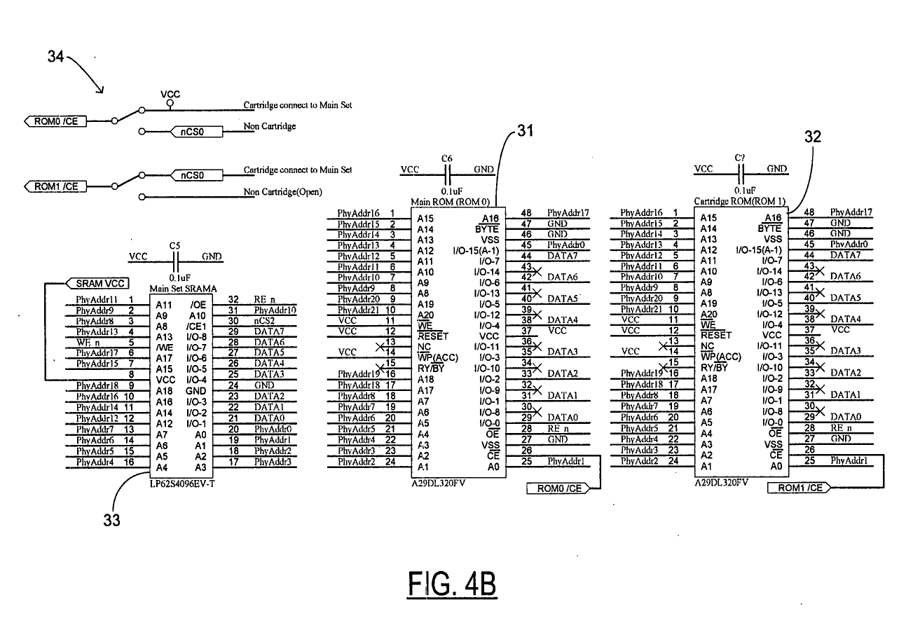

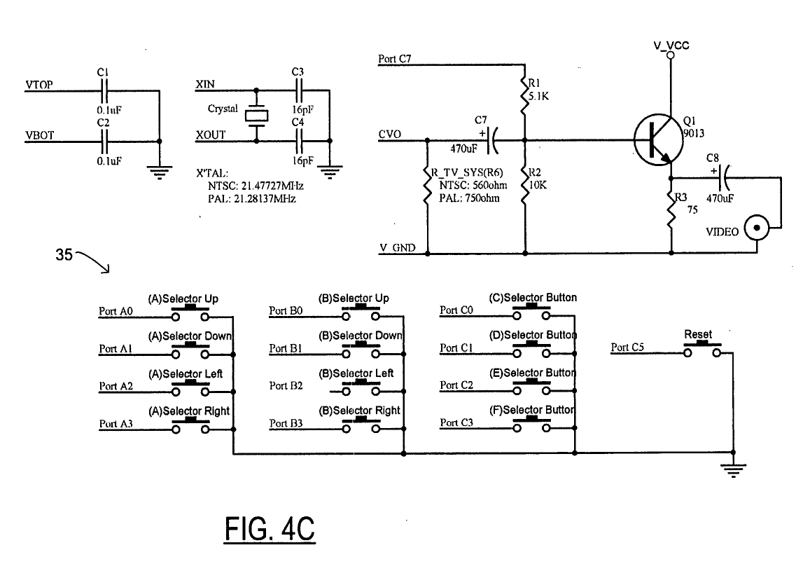

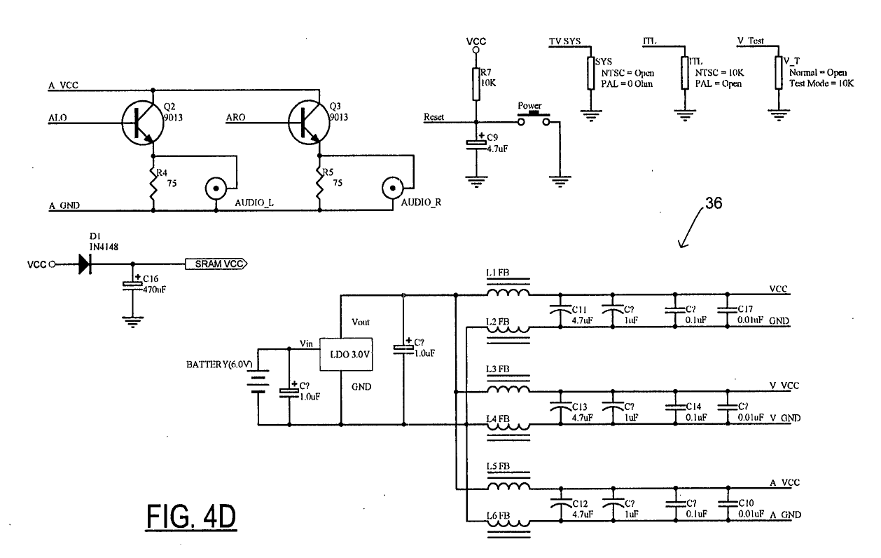

FIG. 4 illustrates the electronic components mounted to a printed circuit board inside device 10. A main processor 30 is preferably comprised of the EMG1000 integrated circuit manufactured by ELAN MicroElectronics Corporation. The EMG1000 includes a microprocessor unit for performing system controller functions and picture and audio processor units. An internal ROM 31 is internally connected to main processor 30 and provides application programs. In a preferred embodiment, there are three main activities of the device, namely an image creation program, an animation program, and a maze game program. These activities are shown by way of example only, and those skilled in the art will recognize may other suitable activity programs. Therefore, the scope of the invention is not limited to any particular activities.

A ROM cartridge 32 may be selectably connected to a 36-pin edge connector on the printed circuit for interconnecting with main unit 30. When connected, cartridge 32 provides application programs for alternative game activities.

A static RAM 33 is provided internally of the unit and coupled to main processor 30 for storing saved information from the application programs. For example, SRAM 33 may provide six RAM storage segments for storing data corresponding to drawings created in a drawing activity application stored in internal ROM 31. The SRAM segments may also be accessed by game applications in internal or external ROM. SRAM 33 is powered by the replaceable batteries powering device 10. A power storage capacitor may be provided so that memory contents can be maintained temporarily while changing batteries, for example. Otherwise, the contents of SRAM 33 may be lost when the batteries are removed or fail.

A cartridge sensing switch 34 is mounted on the printed circuit board and is activated when a ROM cartridge 32 is inserted in order to provide a cartridge sensing signal to main processor 30. Software in the main processor identifies whether a cartridge is present and then configures its operation according to whether external ROM or internal ROM is to be used for providing the application programs for the device.

Push button switches 35 correspond to the control buttons shown in FIG. 1 and provide user control of the device and its applications. A power supply circuit 36 conditions battery voltage as required by the various integrated circuits.

The EMG1000 integrated circuit includes sufficient input ports for the number of switches 35 shown in the preferred embodiment. Additional user interface control elements may be provided on an external ROM cartridge and may utilize additional available input ports via the edge connector. Alternatively, the number of input ports can be reduced by multiplexing the ports amongst multiple control elements or switches as is known in the art.

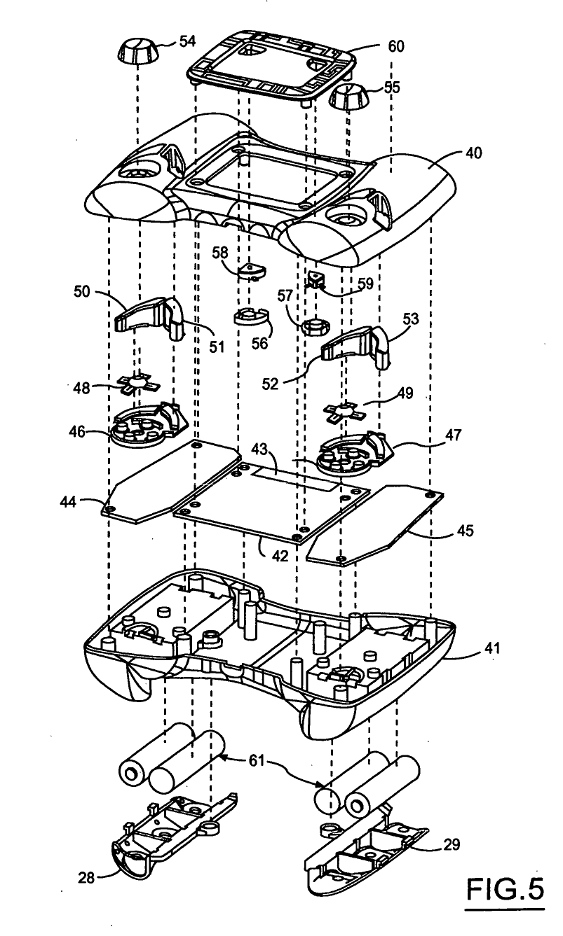

FIG. 5 shows an exploded view of device 10. Upper shell piece 40 cooperates with lower shell piece 41 to create a housing for enclosing printed circuit boards 42, 44, and 45. PCB 42 includes the main components including the EMG1000, SRAM, internal ROM, and edge connector 43 for receiving an external ROM cartridge 32. PCB's 44 and 45 receive membrane switch pads 46 and 47 in alignment with contact areas corresponding to the various pushbutton switches. 4-way operators 48 and 49 overlay the 4-way sections of pads 46 and 47 and snap together with thumb caps 54 and 55. Thumb caps 50-53 nest on top of the single switch elements on pads 46 and 47 and protrude through respective apertures in upper shell piece 40.

Membrane switch pads 56 and 57 for the on/off and reset switches are aligned with corresponding contacts on main PCB 42 and receive button caps 58 and 59. Button caps 58 and 59 protrude through respective apertures in a cover panel 60 mounted on upper shell piece 40.

Back panels 26 and 27 retain batteries 61 in respective battery compartments integrally formed in lower shell piece 41.

A preferred method of operating the illustrated device is shown in FIG. 6. After the device is connected to a television monitor and powered on, it generates a screen display in step 70 that may include a menu bar, a sub-menu bar, and an active window. In each application programmed into the device, various command functions are available through the menu bar (e.g., drawing shapes or saving pictures). Options within each command function (e.g., specifying a shape or specifying a memory slot for saving) are referred to as command sub-functions that are available via the sub-menu bar. The menu bar and sub-menu bar include menu selection icons and sub-menu selection icons, respectively, for identifying respective command functions and sub-functions. Whenever the menu bar is displayed, one of the menu selection icons is highlighted in step 71. When entering an application, a default menu selection icon is highlighted (e.g., an uppermost icon in the menu bar). In step 72, the user navigates through the menu bar by highlighting different menu selection icons in response to the A-button. As each menu selection icon is highlighted, its corresponding sub-menu icons are displayed in the sub-menu bar.

Once a desired menu selection icon corresponding to a desired command function is highlighted, the user presses the F-button to select it in step 73. A default sub-menu selection icon (e.g. an uppermost icon in the sub-menu bar) is highlighted in step 74. In step 75, the user navigates through the sub-menu bar by highlighting different sub-menu selection icons in response to the A-button. Once a desired sub-menu selection icon corresponding to a desired command sub-function is highlighted, the user presses the F-button to select it in step 76.

The command sub-function is executed in step 77. Depending upon the specific sub-function being carried out, directional input from the B-button or on/off sub-function activation controlled by the D-button or the C-button may also be utilized. For example, in a line painting sub-function, a line may be drawn in the active window along a path defined by moving the B-button with the D-button pressed. Or in a rotation sub-function, an area within the active window may be selected for rotating by moving the B-button with the C-button pressed. When the user is finished with the available command sub-functions, the sub-menu bar can be escaped by pressing the E-button in step 78. This activates the menu bar to allow the user to navigate to a different menu selection icon on the menu bar.

FIG. 7 shows an initial screen display when the device of the preferred embodiment is first turned on. The visual display 80 produces an image of a main menu screen 81 with selection icons 82, 83, and 84 corresponding to the available activity and game applications. Icon 82 corresponds in the preferred embodiment to a “My Ideas” button for launching an image creation program. Icon 83 corresponds in the preferred embodiment to an “Art Sparks” button for launching an animation program. Icon 84 corresponds in the preferred embodiment to a “Create a Game” button for launching a maze game program. In the event an expansion ROM cartridge is connected, then other icons for other application programs are displayed.

FIG. 8 is a screen shot showing the image creation program. Display 80 includes a menu bar 85 comprising menu selection icons 90-98 and 100-105 generally along an outer edge of visual display 80. A “Paintbrush” menu selection icon 91 is highlighted, thereby causing a sub-menu bar 86 to display icons corresponding to paintbrush command sub-functions. Active window 87 displays a drawing-in-progress 106 and crosshairs 107. Navigation within menu bar 85 and sub-menu bar 86 are performed using the A-button for moving the highlighting from one icon to the next and using the F-button to select a function or sub-function and the E-button to escape from a function or sub-function. In the particular paintbrush function being shown, crosshairs 107 are moved within active window 87 in response to the B-button. Crosshairs 107 move without a new line being painted if the D-button is not being actuated, and a new line is painted into the image if the D-button is pressed.

Menu icon 90 corresponds to a “shape draw” command function. A sub-menu bar 110 for this function is shown in FIG. 9. Sub-menu icon 11 corresponds to a hexagon shape. Icon 111 is currently highlighted. Other shape icons include a speech balloon icon 112 and a triangle shape icon 113. A divider bar 114 defines a lower section of sub-menu bar 110 which includes modifier icons 115, 116, and 117 for modifying the action of a chosen sub-function. In this case, the modification corresponds to a line size or thickness used to create the drawn shape. Prior to drawing a shape, the user highlights a desired modifier icon to give the shape a desired line size. Modified icon 116 for a medium line size is shown highlighted. The highlighting may be scrolled between modifier icons by repeatedly pressing the F-button, for example. Thus, the menu selection, sub-menu selection, and modifier selection can all be made with the left thumb positioned on the A-button and right thumb positioned at the E-button and F-button. Once all the selections are made, the right thumb is shifted to the B-button and the left thumb is shifted to the C-button and D-button for controlling the application of the chosen function to the drawing image, if any.

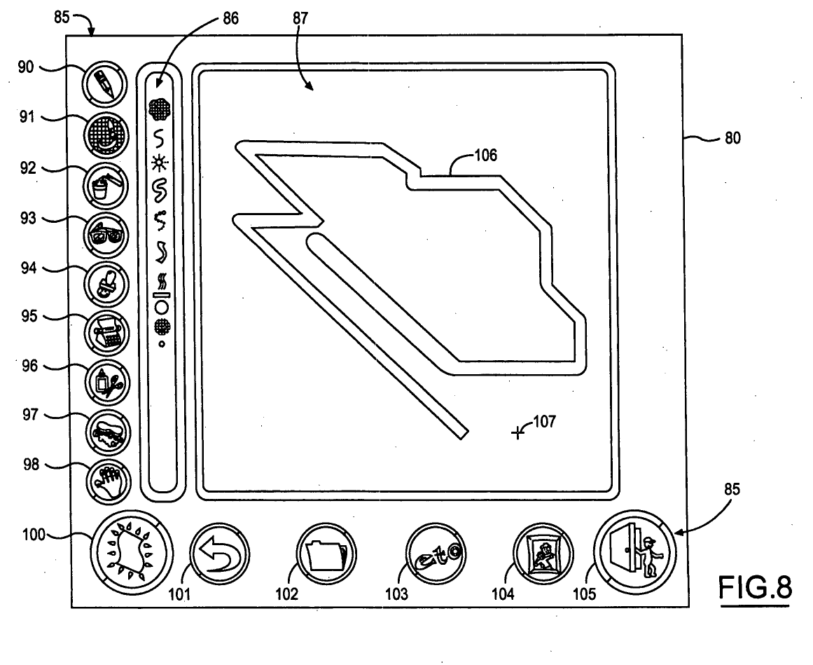

A sub-menu bar 120 is shown in FIG. 10 corresponding to the Paintbrush command function. Command sub-functions include various line styles for drawing clear, fuzzy, dotted, wavy, and other types of line patterns.

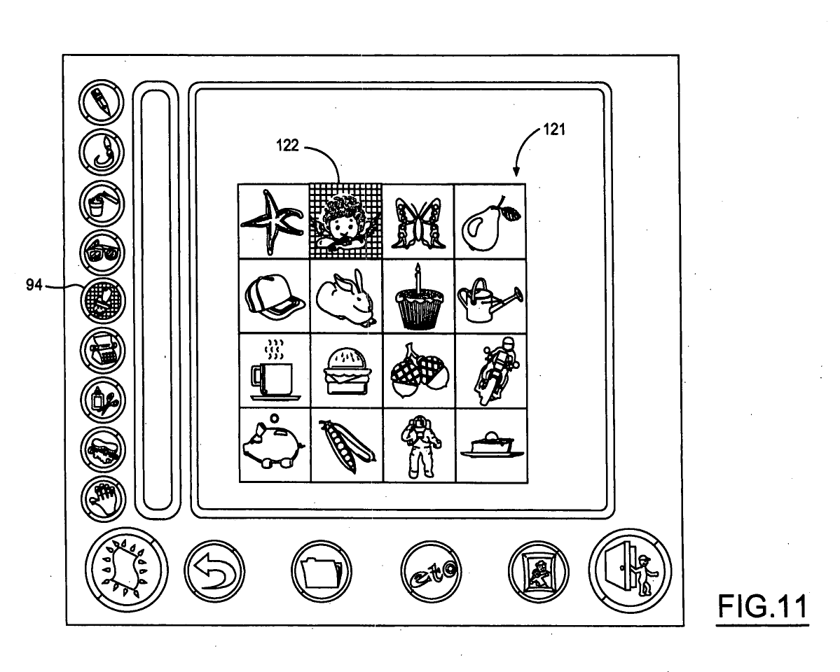

FIG. 11 is a screen shot having a “Clip Art” icon 94 highlighted. For this function command, the sub-menu comprises a selection matrix 121 having a plurality of clip art graphic elements. Matrix 121 is preferably displayed within the active window, temporarily replacing the current drawing image. In a preferred embodiment, when Clip Art icon 94 is first highlighted, no sub-menu appears until the F-button is actuated so that the current drawing image is not disturbed unless the user indicates a desire to access the clip art graphic elements. A graphic element 122 is shown highlighted. The highlighting may be passed from one graphic element to the next using the A-button as previously described. Pressing the F-button restores the current drawing image to the active window with the chosen graphic element placed in a default location. It can then be moved to any desired location using the B-button with the D-button being pressed.

The other menu selection icons in FIG. 8 include Paint Fill button 92, Special Effects button 93 (e.g., lighten, slant, blur), Type button 95 (for adding letters), Cut button 96 (for cutting, moving, and reorienting areas of a drawing), Erase button 97, and Color Select button 98. Menu bar 85 also includes Clear button 100 (for restarting the application), Undo button 101, Save button 102, ETO button 103 (for playing a sound), Slide Show button 104 (for sequentially displaying saved images), and Exit button 105.

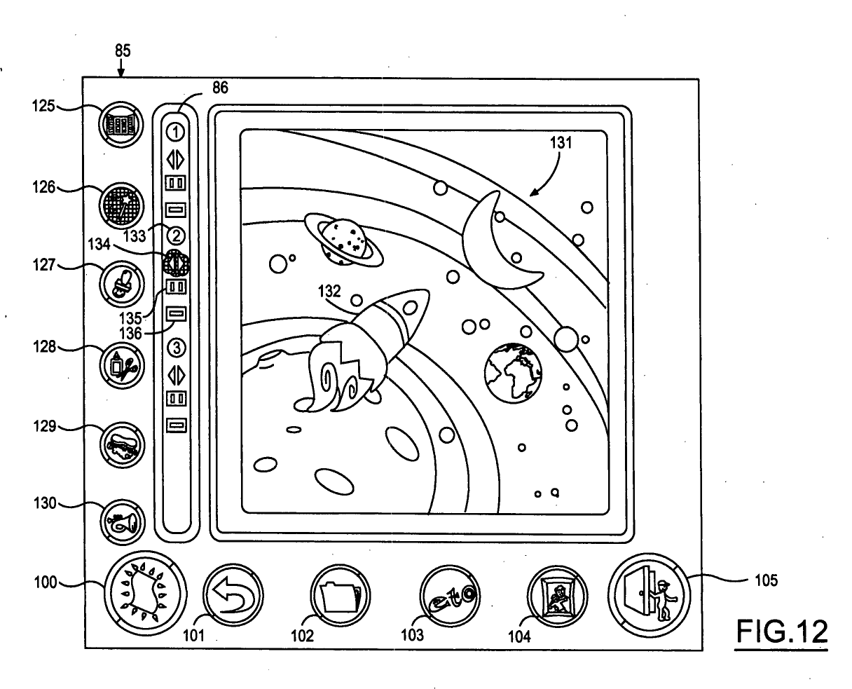

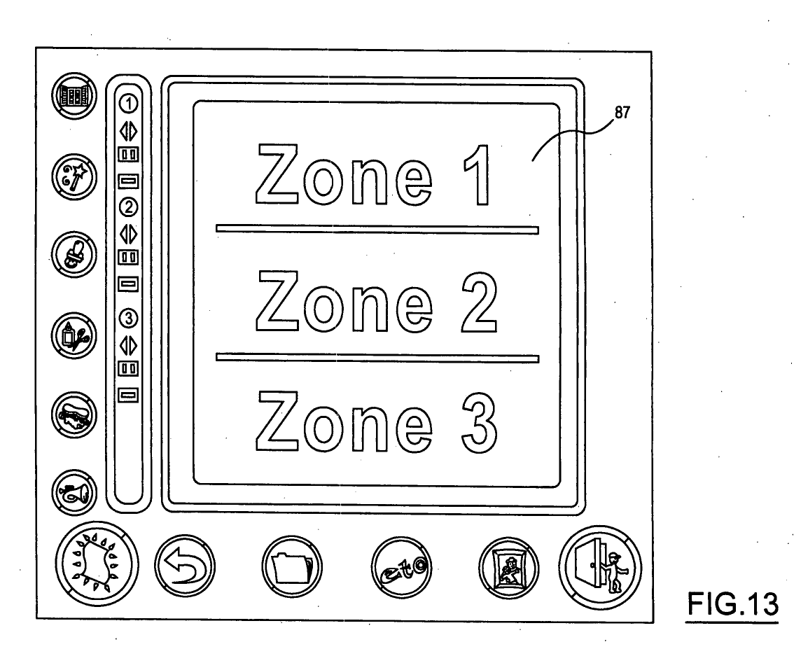

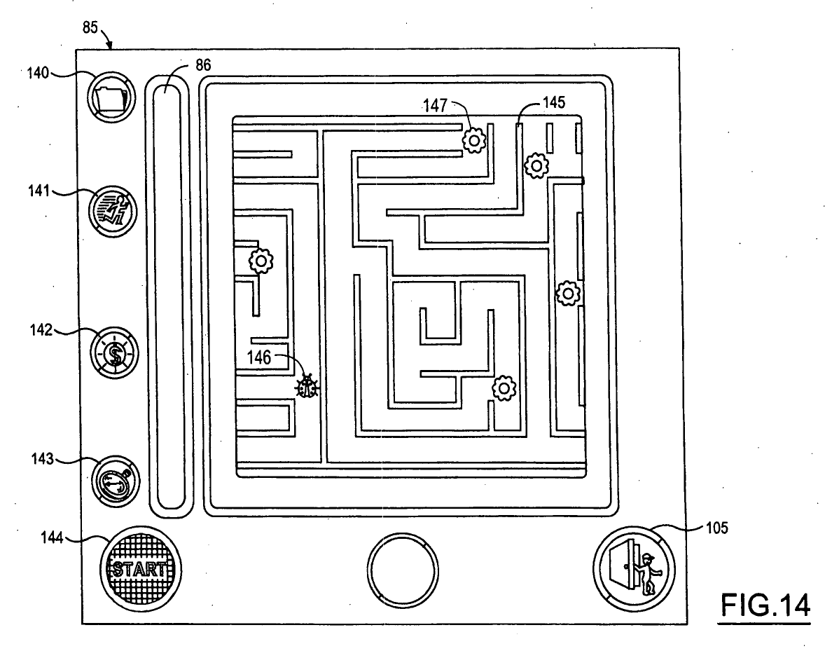

FIG. 12 shows an example screen shot according to the “Art Sparks” animation program. Menu bar 85 includes a Background button 125 (for selecting a background image which may include a saved image from the “My Ideas” application), an Animation button 126, a Clip Art button 127, a Cut/Paste button 128, an Erase button 129, and a Sound Effects button 130. FIG. 12 shows animation button 126 highlighted and the corresponding sub-menu bar 86 being generated. As shown in FIG. 13, active window 87 is separated into three separate horizontal zones for locating and shifting (i.e., imparting horizontal movement to) animated graphic elements. To simplify programming and the user interface, a single animated graphic element chosen from a matrix of animated graphic elements can be placed in each zone.

As shown in FIG. 12, a background image 131 is displayed along with an animated graphic element 132. Element 132 may comprise a plurality of image frames sequentially displayed in a loop in order to provide the animation. Sub-menu bar 86 includes three groups of sub-menu selection icons for controlling animations in each respective zone. For example, a Zone 2 icon 133 may be selected in order to bring up a selection matrix of available animated graphic elements. A chosen graphic element is placed in zone 2 without initially having any shifting motion. By repeatedly selecting a Motion icon 134 with the F-button, horizontal shifting of the chosen element is commanded with the direction of the shifting alternating with each selection of icon 134. A Pause icon is used to stop the shifting motion and a Delete icon is used to erase the corresponding animated graphic element.

FIG. 14 shows a screen shot of the maze game application during game play. Menu bar 85 includes a File Open button 140 (for selecting a saved drawing to use as a background during the maze game), a Choose Character button 141, a Choose Bonus button 142 (for choosing a graphic element associated with treasures placed within the maze), a High Score button 143 (for revealing the best times for completing the maze), and a Start button 144 (which may include a graphic for showing the time remaining to complete a maze). The active window shows a current portion of a maze 145 having passages that connect to other sections or screens of the maze. Moving off a particular screen causes the display to automatically switch to another screen of the maze.

A player's character 146 may be an animated graphic element and is moved throughout the maze in response to the user manipulating the B-button to control a direction of movement. Treasures 147 are collected by moving over them while navigating the maze.

While preferred embodiments of the invention have been shown and described herein, it will be understood that such embodiments are provided by way of example only. Numerous variations, changes, and substitutions will occur to those skilled in the art without departing from the spirit of the invention. In respect of the process disclosed, the steps presented are exemplary in nature, and thus, the order of the steps is not necessary or critical unless otherwise stated. Accordingly, it is intended that the appended claims cover all such variations as fall within the spirit and scope of the invention.

1. An electronic handheld device for outputting video signals to a video monitor with a visual display to create an image, comprising:
a housing;
a controller mounted in said housing for generating video signals for defining a menu area and an active window on said visual display, wherein said menu area includes a plurality of selection icons generally aligned on said visual display for accessing respective imaging functions to be carried out in said active window;
a first directional input mounted on said housing for manipulating using a first hand of a user;
a second directional input mounted on said housing for manipulating using a second hand of said user;
a first set of push buttons mounted on said housing juxtaposed with said first directional input for activating using said first hand of said user; and
a second set of push buttons mounted on said housing juxtaposed with said second directional input for activating using said second hand of said user;
wherein said controller responds to said first directional input and said second set of push buttons for selecting a desired one of said selection icons; and
wherein said controller responds to said second directional input and said first set of push buttons to selectively alter an image within said active window to perform said imaging functions.

2. The device of claim 1 wherein said first and second sets of push buttons are mounted at positions below and substantially adjacent to said first and second directional inputs, respectively, so that a corresponding thumb of said user reaches either said push buttons or said directional inputs.

3. The device of claim 1 wherein said first and second directional inputs each comprises up, down, left, and right push buttons controlled by a 4-way rocker.

4. An electronic handheld device for outputting video signals to a video monitor with a visual display, comprising:
a housing;
a controller mounted in said housing for generating video signals for defining a menu bar, a sub-menu bar, and an active window on said visual display, wherein said menu bar includes a plurality of menu selection icons generally aligned on said visual display, and wherein said sub-menu bar includes a plurality of sub-menu selection icons in a sub-menu area along a side of said menu bar;
a first directional input mounted on said housing for manipulating using a first hand of a user;
a second directional input mounted on said housing for manipulating using a second hand of said user;
a first set of push buttons mounted on said housing juxtaposed with said first directional input for activating using said first hand of said user; and
a second set of push buttons mounted on said housing juxtaposed with said second directional input for activating using said second hand of said user;
wherein said controller highlights a respective menu selection icon in response to manipulation of said first directional input, wherein a respective highlighted menu selection icon is selected in response to activating a first push button in said second set of push buttons for accessing said sub-menu bar and highlighting a respective sub-menu icon, wherein a respective highlighted sub-menu selection icon is selected in response to activating said first push button in said second set of push buttons, wherein said controller generates a graphic element for display in said active window and moves said graphic element in response to manipulation of said second directional input.

5. The device of claim 4 wherein said graphic element comprises a crosshair and wherein said controller modifies an image in said active window along a movement path of said crosshair in response to manipulation of said second directional input while activating a first push button in said first set of push buttons.

6. The device of claim 4 wherein said controller responds to a second push button of said second set of push buttons for escaping from said sub-menu bar to return to said menu bar for highlighting a respective menu selection icon.

7. The device of claim 4 wherein said sub-menu bar includes a plurality of modifier icons for modifying an action associated with a respective highlighted sub-menu selection icon, and wherein said controller highlights a respective modifier icon in response to activating said first push button of said second set of push buttons.

8. The device of claim 7 wherein said modifier icons correspond to a plurality of size selections.

9. The device of claim 4 wherein said controller outlines a selected area of said active window in response to manipulation of said second directional input while activating a second push button of said first set of push buttons.

10. The device of claim 4 wherein accessing said sub-menu generates a selection matrix of graphic elements in said active window, wherein respective graphic elements are highlighted in response to manipulation of said first directional input, and wherein a desired graphic element is selected and placed in said active window in response to activating said first push button of said second set of push buttons.

11. The device of claim 10 wherein said desired graphic element is shifted in said active window in response to manipulation of said second directional input while activating said first push button of said first set of push buttons.

12. The device of claim 10 wherein said desired graphic element is animated with motion in a selected direction, said selected direction being determined by activating said first push button of said second set of push buttons while a respective sub-menu selection icon is highlighted.

13. The device of claim 12 wherein said motion is paused by activating said first push button of said second set of push buttons while a respective sub-menu selection icon is highlighted.

14. The device of claim 4 wherein said first and second sets of push buttons are mounted at positions below and substantially adjacent to said first and second directional inputs, respectively, so that a corresponding thumb of said user reaches either said push buttons or said directional inputs.

15. The device of claim 4 wherein said first and second directional inputs each comprises up, down, left, and right push buttons controlled by a 4-way rocker.

16. The device of claim 4 wherein said controller comprises a microprocessor coupled to a read-only memory, wherein said read-only memory stores program instructions and data for said icons and said graphic elements, and wherein said device further comprises a random access memory for storing user-generated information.

17. The device of claim 16 comprising:
a main internal ROM storing said program instructions and data for a plurality of base applications;
a cartridge connector for accepting an external cartridge including an external ROM, said external ROM storing program instructions and data for an expansion application; and
a cartridge detector for sensing the presence of said external cartridge;
wherein said main internal ROM is disabled and said external ROM is enabled when said presence of said external cartridge is detected.

18. A method of operating an electronic handheld device for controlling a video monitor having a visual display, said electronic handheld device comprising a housing, a controller mounted in said housing for processing video signals, audio signals, and application instructions, a first directional input mounted on said housing for manipulating using a first hand of a user, a second directional input mounted on said housing for manipulating using a second hand of said user, a first set of push buttons mounted on said housing juxtaposed with said first directional input for activating using said first hand of said user, and a second set of push buttons mounted on said housing juxtaposed with said second directional input for activating using said second hand of said user, said method comprising the steps of:
generating a menu bar including a plurality of menu selection icons generally aligned on said visual display, each menu selection icon corresponding to a respective command function;
generating an active window in said visual display;
providing highlighting to one of said menu selection icons;
navigating through said menu bar by moving highlighting between menu selection icons in response to manipulating said first directional input;
selecting a highlighted menu selection icon in response to a first push button of said second set of push buttons;
generating a sub-menu bar including a plurality of sub-menu selection icons, each sub-menu selection corresponding to a respective command sub-function;
providing highlighting to one of said sub-menu selection icons;
navigating through said sub-menu bar by moving highlighting between sub-menu selection icons in response to manipulating said first directional input;
selecting a highlighted sub-menu selection icon in response to said first push button of said second set of push buttons;
executing a command sub-function corresponding to said selected sub-menu selection icon.

19. The method of claim 18 wherein executing said command sub-function is responsive to movement of said second directional input.

20. The method of claim 19 wherein said command sub-function alters an image in said active window in a location indicated by a sub-function tool movably displayed in said active window under control of said second directional input.

21. The method of claim 20 wherein alteration of said image by said command sub-function occurs only when a first push button of said first set of push buttons is being activated.

22. The method of claim 18 wherein said image includes an animated graphic element, said method further comprising the step of:
imparting motion to said animated graphic element in a direction determined in response to selection of a predetermined sub-menu selection icon.

23. The method of claim 18 wherein said image includes an animated graphic element, said method further comprising the step of:
imparting motion to said animated graphic element in a direction determined in response to said second directional input.

24. The method of claim 18 wherein said image includes an animated graphic element selected from a matrix of graphic elements displayed as a command function in said active window, wherein respective graphic elements are highlighted in response to manipulation of said first directional input, and wherein a desired graphic element is selected and placed in said active window in response to activating said first push button of said second set of push buttons.
